(19) United States
(12) Patent Application Publication
(10) Pub. No.: US 2009/0029781 A1
(43) Pub. Date: Jan. 29, 2009

(54) GREASABLE CV-JOINT WHEEL HUB

(75) Inventor: Larry Keith Ayers, Peoria, AZ (US)

Correspondence Address: MESCHKOW & GRESHAM, P.L.C., 5727 NORTH SEVENTH STREET, SUITE 409, PHOENIX, AZ, 85014, US

(73) Assignee: AYERS GEAR AND MACHINE, INC., Phoenix, AZ (US)

(21) Appl. No.: 12/246,736

(22) Filed: Oct. 7, 2008

Related U.S. Application Data
(63) Continuation-in-part of application No. 11/211,998, filed on Aug. 24, 2005.

(51) Int. Cl. F16C 1/24

(52) U.S. Cl. 464/7

(57) ABSTRACT

A greasable wheel hub (20) using a constant-velocity (CV) joint (22) as a hub spindle is taught. The wheel hub (20) includes a hub cover (28) attached to a hub body (24), which in turn is attached to a CV housing (32) and a CV bearing (34), both of which are portions of the CV joint (22). A grease (46) is injected through a grease fitting (36) into a grease trough (42) at the interface between the hub cover (28) and the hub body (24). This grease (46) is then conveyed through a plurality of grease passages (44) to the CV housing (32), where it provides lubrication for the CV joint (22). Another grease (47) is injected through another grease fitting (37) into another grease trough (43). This grease (47) is then conveyed though a plurality of other grease passages (45) and a plurality of grease channels (49) to the CV bearing (34), where it provides lubrication.

### RELATED INVENTION

The present invention is a continuation in part (CIP) of “Greasable CV-Joint Wheel Hub,” U.S. patent application Ser. No. 11/211,998, filed 24 Aug. 2005, which is incorporated by reference herein.

### TECHNICAL FIELD OF THE INVENTION

The present invention relates to the field of wheel hubs. More specifically, the present invention relates to the field of motor-vehicle wheel hubs utilizing constant-velocity joints as spindles.

### BACKGROUND OF THE INVENTION

It is common to use constant-velocity (CV) joints as spindles for motor vehicle wheels. The use of CV joints allows the transfer of energy through an angular connection. This allows for the use of wheels with independent suspension and significantly increases the ability of the wheel to maintain contact with the surface over which the vehicle is traveling.

These become especially important when the surface is irregular and/or the vehicle is maintaining a high rate of speed for that surface. In activities such as off-road racing, where the terrain in rough and the relative speed is high, good suspension becomes critical. This virtually mandates the use of independent suspension and CV joints on all four wheels.

One primary problem exists with conventional CV joints: that of lubrication. The inherent structure of the conventional CV joint makes lubrication difficult. With conventional CV joints, lubrication requires disassembly. In a race, this is not practical. The conventional approach is therefore to replace the wheel hub, with its CV joint, in the field.

Hub replacement is time consuming. In a race, even a short time encompassed in a pit stop can mean the difference between winning and losing. Therefore, any methodology that decreases the pit-stop time is highly desirable.

### SUMMARY OF THE INVENTION

Accordingly, it is an advantage of the present invention that a greasable CV-joint wheel hub is provided.

It is another advantage of the present invention that a greasable wheel hub is provided that allows the CV joint acting as a spindle therein to be lubricated without disassembly.

It is another advantage of the present invention that a greasable wheel hub is provided that allows both the CV joint itself and its primary bearing to be lubricated in the field without dismounting the hub.

The above and other advantages of the present invention are carried out in one form by a wheel hub for a motor vehicle using a CV joint as a hub spindle. The wheel hub incorporates a CV housing realized as a portion of the CV joint, a hub body configured to mate with the CV housing, and a hub cover, where an inner face of the hub cover is configured to mate with an outer face of the hub body. A grease fitting is coupled into a fitting socket formed onto an outer face of the hub cover. A grease trough coupled to the fitting socket is formed onto either the inner face of the hub cover or the outer face of the hub body. A grease passage is formed through the hub body so as to extend from the grease trough to the CV housing. The grease fitting is configured to permit the injection of a grease into the grease trough, and the grease passage is configured to convey the grease from the grease trough to the CV housing.

The above and other advantages of the present invention are carried out in another form by a wheel hub for a motor vehicle using a CV joint as a hub spindle. The wheel hub includes a CV bearing coupled to a CV housing, where both the CV bearing and the CV housing are portions of the CV joint, a hub body configured to mate with the CV housing, and a hub cover having an inner face configured to mate with an outer face of the hub body. A grease fitting is coupled into a fitting socket formed onto an outer face of the hub cover. A grease trough coupled to the fitting socket is formed onto either the inner face of the hub cover or the outer face of the hub body. A grease passage is formed through the hub body so as to extend from the grease trough to the CV housing. A grease channel is formed in an outer surface of the CV housing and configured to extend from the grease passage to the CV bearing. The grease fitting is configured to permit the injection of a grease into the grease trough, the grease passage is configured to convey the grease from the grease trough to the CV housing, and the grease channel is configured to convey the grease from the grease passage to the CV bearing.

### BRIEF DESCRIPTION OF THE DRAWINGS

A more complete understanding of the present invention may be derived by referring to the detailed description and claims when considered in connection with the Figures, wherein like reference numbers refer to similar items throughout the Figures, and:

FIG. 1 shows a side view depicting a portion of a wheel hub in accordance with a preferred embodiment of the present invention;

FIG. 2 shows an end view depicting the wheel hub portion of FIG. 1 in accordance with a preferred embodiment of the present invention;

FIG. 3 shows a first cross-sectional side view depicting a section of the wheel hub portion of FIGS. 1 and 2 in accordance with a preferred embodiment of the present invention;

FIG. 4 shows a second cross-sectional side view depicting a section of the wheel hub portion of FIGS. 1 and 2 in accordance with a preferred embodiment of the present invention; and

FIG. 5 shows an oblique cut away view of a wheel hub in accordance with a preferred embodiment of the present invention.

### DETAILED DESCRIPTION OF THE PREFERRED EMBODIMENTS

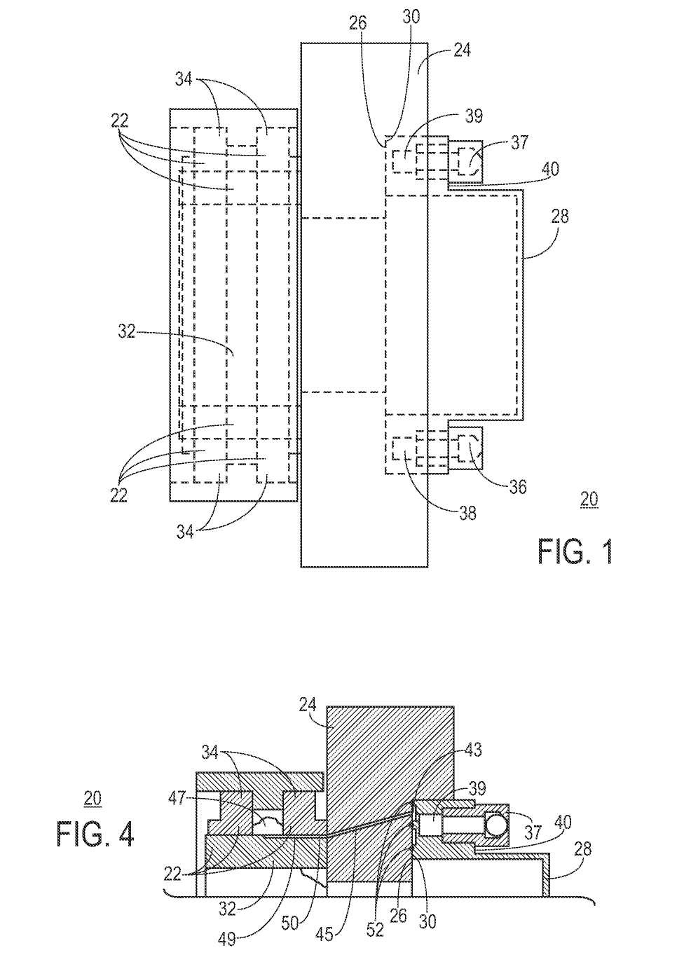

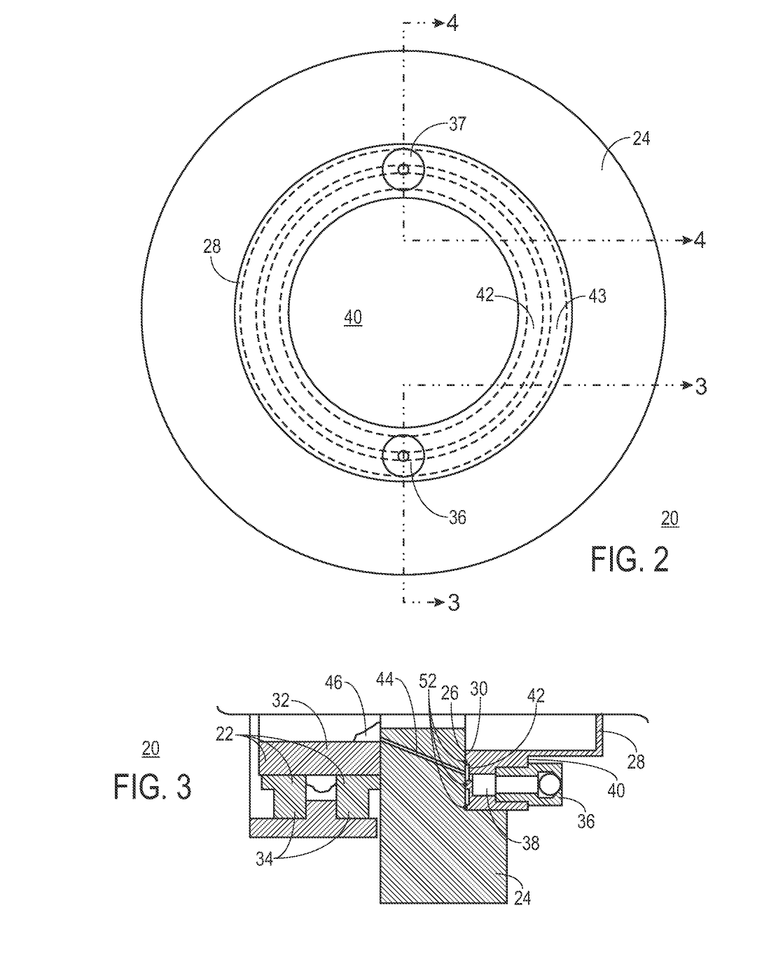

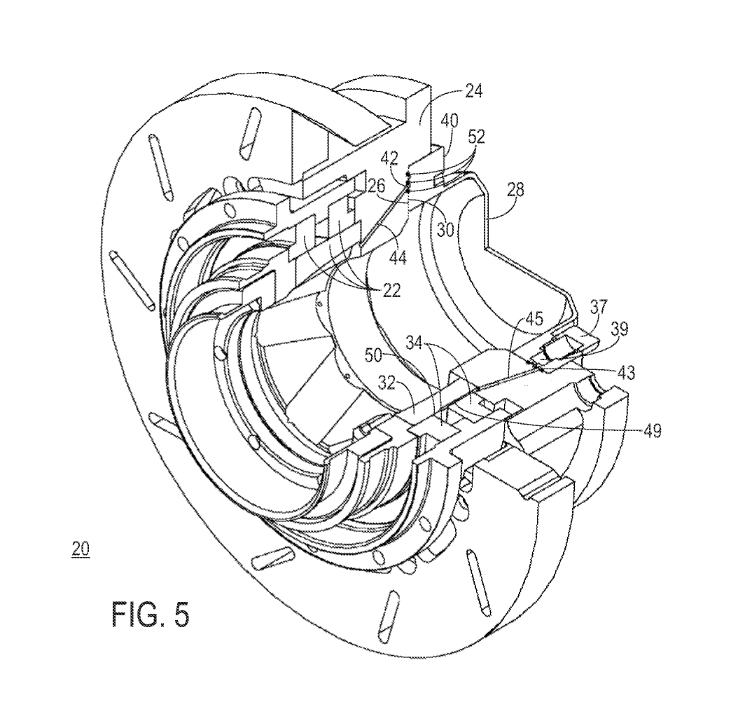

FIGS. 1 and 2 show side and end views, respectively, of a portion of wheel hub 20 in accordance with a preferred embodiment of the present invention. FIGS. 3 and 4 show first and second cross-sectional side views of sections of wheel hub 20 in accordance with a preferred embodiment of the present invention. FIG. 5 shows an oblique cut-away view of a wheel hub 20 for a motor vehicle in accordance with one embodiment of the present invention. In addition, FIG. 5 shows a brake rotor 21 to exemplify the context within which wheel hub 20 may be typically used. The following discussion refers to FIGS. 1 through 5.

Wheel hub 20 is a motor vehicle wheel hub utilizing a constant-velocity (CV) joint 22 as a hub spindle.

Wheel hub 20 is a greasable wheel hub. That is, wheel hub 20 contains provisions for greasing CV joint 22 without the disassembly of wheel hub 20, and without the removal of wheel hub 20 from the motor vehicle (not shown).

In construction, wheel hub 20 is made up of a hub body 24, to which other components of wheel hub 20 are attached. Hub body 24 may include or have attached thereto other components not relevant to this discussion and not depicted in FIGS. 1-4, such as brake disks, etc. Those skilled in the art will appreciate that the inclusion of such other components does not depart from the spirit of the present invention.

Hub body 24 has an outer face 26. A hub cover 28 is attached to hub body 24. Hub cover 28 has an inner face 30. Outer face 26 of hub body 24 and inner face 30 of hub cover 28 are configured to mate together to provide a conventional contaminate barrier for wheel hub 20.

Hub body 24 is configured to mate with a CV housing 32. Coupled to CV housing 32 is a CV bearing 34. CV housing 32 and CV bearing 34 are realized as portions of CV joint 22. That is, CV joint 22 includes CV housing 32 and CV bearing 34, along with other components not depicted nor discussed herein.

It is a primary purpose of wheel hub 20 to allow for the lubrication of CV joint 22 without the disassembly or dismounting of wheel hub 20. The lubrication of CV joint 22 is in two forms: the lubrication of CV joint 22 proper; and the lubrication of CV bearing 34.

The following discussion refers to FIGS. 1, 2, 3, and 5, and discusses the lubrication of CV joint 22.

A joint grease fitting 36 is coupled to a joint fitting socket 38 formed on an outer face 40 of hub cover. At the interface between hub cover 28 and hub body 24 is a joint grease trough 42 (shown as an inner joint grease trough 42 in FIG. 2). Joint grease trough 42 is configured to communicate with (i.e., receive grease from) joint fitting socket 38.

Joint grease trough 42 is formed at the interface between hub cover 28 and hub body 24. In the embodiment of FIG. 3, joint grease trough 42 is formed as a groove within inner face 30 of hub cover 28. Those skilled in the art will appreciate that this is not a requirement of the present invention. Joint grease trough 42 may be formed in an alternative manner, e.g., as either a groove or protrusions on either inner face 30 of hub cover 28 or outer face 26 of hub body 24, without departing from the spirit of the present invention.

At least one joint grease passage 44 is formed through hub body 24. Joint grease passage 44 extends from joint grease trough 42 to CV housing 32.

During the lubrication of CV joint 22, a joint grease 46 suitable for the lubrication of CV joint 22, is injected into joint grease fitting 36, and thence through joint fitting socket 38 and into joint grease trough 42. Joint grease 46 is then conveyed by joint grease passage 44 from joint grease trough 42, through hub body 24, and to CV housing 32, where it is then able to lubricate CV joint 22.

The following discussion refers to FIGS. 1, 2, 4, and 5, and discusses the lubrication of CV bearing 34.

A bearing grease fitting 37 is coupled to a bearing fitting socket 39 formed on outer face 40 of hub cover. At the interface between hub cover 28 and hub body 24 is a bearing grease trough 43 (shown as an outer bearing grease trough 43 in FIG. 2). Bearing grease trough 43 is configured to communicate with (i.e., receive grease from) bearing fitting socket 39.

Bearing grease trough 43 is formed at the interface between hub cover 28 and hub body 24. In the embodiment of FIG. 4, Bearing grease trough 43 is formed as a groove within inner face 30 of hub cover 28. Those skilled in the art will appreciate that this is not a requirement of the present invention. Bearing grease trough 43 may be formed in an alternative manner, e.g., as either a groove or protrusions on either inner face 30 of hub cover 28 or outer face 26 of hub body 24, without departing from the spirit of the present invention.

At least one bearing grease passage 45 is formed through hub body 24. Bearing grease passage 45 extends through hub body 24 from bearing grease trough 43 to CV housing 32.

At least one bearing grease channel 49 is formed along an outer surface 50 of CV housing 32. Bearing grease channel 49 extends along CV housing 32 from bearing grease passage 45 to CV bearing 34.

During the lubrication of CV bearing 34, a bearing grease 47 suitable for the lubrication of CV bearing 34 is injected into bearing grease fitting 37, and thence through bearing fitting socket 39 and into bearing grease trough 43. Bearing grease 47 is conveyed by bearing grease passage 45 from bearing grease trough 43, through hub body 24, and to CV Housing 32, then is conveyed by bearing grease channel 49 from bearing grease passage 45, along outer surface 50 of CV housing 32, and to CV bearing 34, where it is then able to lubricate CV bearing 34.

The following discussion refers to FIGS. 1 through 5.

Joint and bearing grease passages 44 and 45, and bearing grease channels 49, are desirably plural. In the preferred embodiment, there are six joint grease passages 44, and six bearing grease passages 45 and six associated bearing grease channels 49, with each bearing grease passage 45 connecting up with one corresponding bearing grease channel 49. Two joint grease passages 44, two bearing grease passages 45, and two bearing grease channels 49 are shown in the combination of FIGS. 3 and 4. Those skilled in the art will appreciate that the exact number of grease passages 44 and grease channels 48 is not a requirement of the present invention. Differing numbers of each may be incorporated without departing from the spirit of the present invention.

Joint grease passages 44 are desirably substantially identical, i.e., pass through hub body 24 in substantially identical manners. Similarly, Grease passages 244 bearing grease passages 45 are desirably substantially identical, and bearing grease channels 49 are desirably substantially identical. Those skilled in the art will appreciate, however, that this is not a requirement of the present invention. Variations in the routing and dimensions of joint grease passages 44, bearing grease passages 45, and bearing grease channels 49 may be realized without departing from the spirit of the present invention.

Joint and bearing grease 46 and 47 would tend to migrate out of joint and bearing grease troughs 42 and 43, respectively. In the preferred embodiment, O-rings 52 are used surrounding and between joint and bearing grease troughs 42 and 43. In this manner, O-rings 52 maintain joint grease 46 in joint grease trough 42 and bearing grease 47 in bearing grease trough 43. In this embodiment, O-rings 52 are fitted under pressure into small grooves (not shown) in outer face 26 of hub body 24 and inner face 30 of hub cover 28. Those skilled in the art will appreciate that this is not a requirement of the present invention. Other methods of securing O-rings 52 may be used without departing from the spirit of the present invention.

In summary, the present invention teaches a greasable CV-joint wheel hub 20. Wheel hub 20 allows a CV joint 22 acting as a hub spindle to be lubricated without disassembly. Wheel hub 20 also allows both a CV joint 22 and its primary bearing 34 to be lubricated in the field without dismounting the hub.

Although the preferred embodiments of the invention have been illustrated and described in detail, it will be readily apparent to those skilled in the art that various modifications may be made therein without departing from the spirit of the invention or from the scope of the appended claims.

What is claimed is:

1: A wheel hub for a motor vehicle, said wheel hub using a constant-velocity (CV) joint as a hub spindle, and said wheel hub comprising:
a CV housing realized as a portion of said CV joint;
a hub body configured to mate with said CV housing and having an outer face;
a hub cover having an inner face configured to mate with said outer face of said hub body and having an outer face;
a fitting socket formed onto said outer face of said hub cover;
a grease trough coupled to said fitting socket and formed onto one of said inner face of said hub cover and said outer face of said hub body;
a grease passage formed through said hub body so as to extend from said grease trough to said CV housing;
a grease fitting coupled to said fitting socket; and
wherein:
said grease fitting is configured to permit the injection of a grease into said grease trough; and
said grease passage is configured to convey said grease from said grease trough to said CV housing.

2: A wheel hub as claimed in claim 1 wherein:
said grease passage is one of a plurality of grease passages;
each of said grease passages is formed through said hub body so as to extend from said grease trough to said CV housing; and
each of said grease passages is configured to convey said grease from said grease trough to said CV joint.

3: A wheel hub as claimed in claim 1 additionally comprising an O-ring configured to maintain said grease within said grease trough.

4: A wheel hub as claimed in claim 1 wherein:
said grease is a first grease;
said grease fitting is a first grease fitting;
said fitting socket is a first fitting socket;
said grease trough is a first grease trough;
said grease passage is a first grease passage;
said wheel hub additionally comprises:
a CV bearing realized as a portion of said CV joint and coupled to said CV housing;
a second fitting socket formed onto said outer face of said hub cover;
a second grease trough coupled to said second fitting socket and formed onto one of said inner face of said hub cover and said outer face of said hub body;
a second grease passage formed through said hub body so as to extend from said second grease trough to said CV housing;
a grease channel formed along an outer surface of said CV housing so as to extend from said second grease passage to said CV bearing; and
a second grease fitting coupled to said second fitting socket;
said second grease fitting is configured to permit the injection of a second grease into said second grease trough;
said second grease passage is configured to convey said second grease from said second grease trough to said grease channel; and
said grease channel is configured to convey said second grease from said second grease passage to said CV bearing.

5: A wheel hub as claimed in claim 4 wherein:
said second grease passage is one of a plurality of second grease passages;
each of said second grease passages is formed through said hub body so as to extend from said second grease trough to said CV housing;
said grease channel is one of a plurality of grease channels;
each of said grease channels is formed along an outer surface of said CV housing so as to extend from one of said second grease passages to said CV bearing;
each of said second grease passages is configured to convey said second grease from said second grease trough to one of said grease channels; and
each of said grease channels is configured to convey said second grease from one of said second grease passages to said CV bearing.

6: A wheel hub as claimed in claim 4 wherein:
said first grease passage is one of a plurality of substantially identical first grease passages;
said second grease passage is one of a plurality of substantially identical second grease passages; and
said grease channel is one of a plurality of substantially identical grease channels.

7: A wheel hub as claimed in claim 4 additionally comprising a plurality of O-rings, wherein each of said O-rings is configured to maintain one of said first and second greases in one of said first and second grease troughs, respectively.

8: A wheel hub as claimed in claim 4 wherein:
said second grease trough is substantially coincident with said first grease trough; and
said second grease is substantially identical to said first grease.

9: A wheel hub for a motor vehicle, said wheel hub using a constant-velocity (CV) joint as a hub spindle and said wheel hub comprising:
a CV bearing realized as a portion of said CV joint;
a CV housing realized as a portion of said CV joint, coupled to said CV bearing, and having an outer surface;
a hub body configured to mate with said CV housing and having an outer face;
a hub cover having an inner face configured to mate with said outer face of said hub body and having an outer face;
a fitting socket formed onto said outer face of said hub cover;
a grease trough coupled to said fitting socket and formed onto one of said inner face of said hub cover and said outer face of said hub body;
a grease passage formed through said hub body and configured to extend from said grease trough to said CV housing;
a grease channel formed in said outer surface of said CV housing and configured to extend from said grease passage to said CV bearing;
a grease fitting coupled to said fitting socket; and
wherein:
said grease fitting is configured to permit the injection of a grease into said grease trough;
said grease passage is configured to convey said grease from said grease trough to said grease channel; and
said grease channel is configured to convey said grease from said grease passage to said CV bearing.

10: A wheel hub as claimed in claim 9 wherein:
said grease is a first grease;
said grease fitting is a first grease fitting;
said fitting socket is a first fitting socket;
said grease trough is a first grease trough;
said grease passage is a first grease passage;
said wheel hub additionally comprises:
a second fitting socket formed onto said outer face of said hub cover;
a second grease trough coupled to said second fitting socket and formed onto one of said inner face of said hub cover and said outer face of said hub body;
a second grease passage formed through said hub body so as to extend from said second grease trough to said CV housing;
a second grease fitting coupled to said second fitting socket;
said second grease fitting is configured to permit the injection of a second grease into said second grease trough; and
said second grease passage is configured to convey said second grease from said second grease trough to said CV joint.

11: A wheel hub as claimed in claim 10 wherein:
said first grease passage is one of a plurality of first grease passages;
said grease channel is one of a plurality of grease channels.

12: A wheel hub as claimed in claim 11 wherein:
each of said first grease passages is configured to convey said first grease from said first grease trough to one of said grease channels; and
each of said grease channels is configured to convey said first grease from one of said first grease passages to said CV bearing.

13: A wheel hub as claimed in claim 10 wherein said second grease passage is one of a plurality of second grease passages.

14: A wheel hub as claimed in claim 13 wherein each of said second grease passages is configured to convey said second grease from said second grease trough to said CV joint.

15: A wheel hub as claimed in claim 10 additionally comprising a plurality of O-rings, wherein each of said O-rings is configured to maintain one of said first and second greases in one of said first and second grease troughs, respectively.

16: A wheel hub for a motor vehicle, said wheel hub using a constant-velocity (CV) joint as a hub spindle and said wheel hub comprising:
a CV bearing realized as a portion of said CV joint;
a CV housing realized as a portion of said CV joint, coupled to said CV bearing, and having an outer surface;
a hub body configured to mate with said CV housing and having an outer face;
a hub cover having an inner face configured to mate with said outer face of said hub body and having an outer face;
a first fitting socket formed onto said outer face of said hub cover;
a first grease trough coupled to said first fitting socket and formed onto one of said inner face of said hub cover and said outer face of said hub body;
a first grease passage formed through said hub body so as to extend from said first grease trough to said CV housing;
a first grease fitting coupled to said first fitting socket;
a second fitting socket formed onto said outer face of said hub cover;
a second grease trough coupled to said second fitting socket and formed onto one of said inner face of said hub cover and said outer face of said hub body;
a second grease passage formed through said hub body and configured to extend from said second grease trough to said CV housing;
a grease channel formed in said outer surface of said CV housing and configured to extend from said second grease passage to said CV bearing;
a second grease fitting coupled to said second fitting socket; and
wherein:
said first grease fitting is configured to permit the injection of a first grease into said first grease trough;
said first grease passage is configured to convey said first grease from said first grease trough to said CV housing;
said second grease fitting is configured to permit the injection of a second grease into said second grease trough;
said second grease passage is configured to convey said second grease from said second grease trough to said grease channel; and
said grease channel is configured to convey said second grease from said second grease passage to said CV bearing.

17: A wheel hub as claimed in claim 16 wherein:
said first grease passage is one of a plurality of first grease passages;
each of said first grease passages is formed through said hub body so as to extend from said first grease trough to said CV housing; and
each of said first grease passages is configured to convey said first grease from said first grease trough to said CV joint.

18: A wheel hub as claimed in claim 17 wherein:
said second grease passage is one of a plurality of second grease passages;
said grease channel is one of a plurality of grease channels;
each of said second grease passages is formed through said hub body and configured to extend from said second grease trough to said CV housing;
each of said grease channels is formed in said outer surface of said CV housing and configured to extend from said second grease passage to said CV bearing;
each of said second grease passages is configured to convey said second grease from said second grease trough to one of said grease channels; and
each of said grease channels is configured to convey said second grease from one of said second grease passages to said CV bearing.

19: A wheel hub as claimed in claim 16 additionally comprising a plurality of O-rings, wherein:
one of said O-rings is configured to maintain said first grease within said first grease trough; and
one of said O-rings is configured to maintain said second grease within said second grease trough.
